(19) United States
(12) Patent Application Publication
(10) Pub. No.: US 2010/0227641 A1
(43) Pub. Date: Sep. 9, 2010

(54) MOBILE RADIO COMMUNICATIONS DEVICE CONFIGURATION

(75) Inventor: Pierr-Jean Muller, Charenton Le Pont (FR)

Correspondence Address: DICKSTEIN SHAPIRO LLP, 1633 Broadway, NEW YORK, NY, 10019, US

(73) Assignee: NEC CORPORATION, Tokyo (JP)

(21) Appl. No.: 12/095,638

(22) PCT Filed: Dec. 12, 2006
(86) PCT No.: PCT/JP2006/325134

§ 371 Date: May 30, 2008

(30) Foreign Application Priority Data
Dec. 13, 2005 (GB) 0525330.7

(51) Int. Cl. H04M 1/725

(52) U.S. Cl. 455/552.1

(57) ABSTRACT

There is provided a mobile radio communications device 10 comprising a handset 12 having an antenna 14 which is connected to transmitting/receiving circuitry 16 operatively connected in a standard manner to a processor 18 and memory 20. In addition, the handset 12 includes a non-volatile memory area 22 which is arranged to receive and store a preference list which indicates, on a country-by-country basis, the preferred manual PLMN selection mode to be adopted for each country.

### TECHNICAL FIELD

The present invention relates to a method and related apparatus for configuring a mobile radio communications device for connection to one of a plurality of mobile radio communications device networks.

### BACKGROUND ART

In operation, a mobile radio communications device can often achieve connectivity to one of a plurality of Public Land Mobile Networks (PLMN) and means are commonly provided within the mobile radio communications device handset to allow for a manual selection procedure in which one of the PLMNs indicated as available to the handset can be selected.

Manual selection is a potentially useful tool such as when a particular selected PLMN is not found to be providing adequate signal strength or quality, or indeed when it is required to remove a PLMN from a forbidden PLMN list. However, in other circumstances, the manner of selecting the PLMN can prove disadvantageously limited since it can serve to prevent the subscriber employing the handset from receiving the best possible network service.

According to the current third generation standard 3GPPTS 23.122, there is proposed one single manual PLMN selection procedure and this can prove disadvantageously limiting depending upon the particular roaming scenario that the device handset might find itself in. In addition to other limitations, operator revenue may also be comprised.

There are currently three generally recognized roaming scenarios outlined as follows.

The first, so called national roaming, occurs when the mobile radio communications device receives a service from a PLMN that is made available in the same country as the handset's home PLMN (HPLMN) either anywhere nationally or on a regional basis.

International roaming occurs where the mobile radio communications device is arranged to receive a service on a PLMN from a different country from that within which the HPLMN arises.

The last scenario is known as friendly international roaming and exists where the mobile radio communications device is arranged to receive a service on a PLMN of a different country from that of the HPLMN, but where it is known that the particular country concerned can offer a PLMN that is “friendly” to the HPLMN, for example wherein it is provided by the same, or related, network operator.

A plurality of manual PLMN selection modes is also available which provide for different modes of connection of the mobile radio communications device handset to the network. These are outlined as follows:

Mode I manual PLMN selection is that provided for by way of the 3GPPTS 23 1222 standard and allows for the mobile radio communications device handset to first indicate to the user which PLMNs are available. Once the user has made a manual selection of one of those PLMNs, the mobile radio communications device handset then attempts to obtain normal service on that selected PLMN. It should be appreciated that, once selected, the mobile radio communications device handset remains on that selected PLMN and so will not attempt re-selection to another PLMN even if coverage offered by the selected PLMN is lost.

Mode II manual PLMN selection again involves the mobile radio communications device indicating to the user which PLMNs are available. As with Mode I, only once the user makes a manual selection does the mobile radio communications device attempt to obtain normal service on the selected PLMN. However, the main difference between Mode I and Mode II is that in the latter, the mobile radio communications device remains in an automatic connection mode by way of which it makes a periodic search for the highest priority PLMN available, which can include the HPLMN, while the mobile radio communications device handset is roaming. It should be appreciated that, following such a periodic search, during re-selection of when in an out-of-service area from its registered PLMN, if the mobile radio communications device handset finds a high priority PLMN (which of course is likely to be the HPLMN in the handset's home country) and according to the PLMN selector lists, the mobile radio communications device will automatically select and register to this identified PLMN.

Finally, in Mode III, procedures similar to those illustrated in relation to Mode I are followed. However, whenever the user equipment switches off during manual PLMN selection, the mobile radio communications device is arranged at switch-on to operate in automatic mode. The adoption of Mode III assists in avoiding a situation in which the user is locked into an “out service” scenario wherein, at switch-on, it will not be possible to locate an alternative PLMN upon which service is available.

As mentioned above, disadvantages arise in relation to the manner in which the current modes of manual selection are made available. For example, during national roaming by way of current GPP implementation, such as that offered by Mode I manual selection, the user can permanently select a PLMN that need not be its HPLMN even if the HPLMN is available. The operator then loses revenue but the user may also disadvantageously experience fewer or otherwise limited, services. The user may also experience higher costs and, if coverage by the selected PLMN is lost, the user may find that they stay permanently out of service.

### DISCLOSURE OF INVENTION

The present invention seeks to provide for a mobile radio communications device configuration method and apparatus offering advantages over known such methods and apparatus.

According to a first aspect of the present invention there is provided a mobile radio communications device arranged for connection to a plurality of networks and by way of a plurality of manual selection modes, and arranged such that the selection mode employed is dependent upon the country within which the mobile radio communications device operates.

Through allowing the manual mode procedure to be responsive to an identification of the country within which the mobile radio communications device is located, home operator revenues can be protected and, indeed, the quality of service received by the mobile radio communications device user can be maintained.

Preferably, the mobile radio communications device includes storage means within which there is stored a preferred manual selection mode for each of the said plurality of countries.

Further, the device can be arranged with a default mode in the absence of a preferred mode being indicated for any particular country.

Preferably, the mobile radio communications device comprises a non-volatile memory area for storing the preferred manual selection mode. However, as an alternative, the preferred manual selection mode can be located on the USIM.

In particular, the preferred manual selection mode can form part of a preference list stored on the mobile radio communications device.

Also, the mobile radio communications device can be arranged to receive the preferred manual selection mode and, in particular, the preference list, from the network operator.

According to another aspect of the present invention, there is provided a method of connecting a mobile radio communications device to one of a plurality of networks and by way of one of a plurality of manual connection modes, including the step of identifying the country within which the mobile radio communications device is operating and determining which of the plurality of manual connection modes is employed on the basis of the country identified.

As above, the invention advantageously prevents a manual selection mode being selected that might indeed prove inappropriate for the country concerned, and potentially detrimental to home-operator revenues and the quality of service received by a user.

Preferably, the method includes the step of referring to a stored preferred manual selection where, in particular, the manual selection mode can form part of a stored preference list wherein a separate list is provided for each of the said plurality of countries.

The invention can also include the step of offering a default mode should any particular country not offer a preferred manual selection mode.

According to yet another aspect of the present invention, there is provided a method of configuring a mobile radio communications device for connection to one of a plurality of networks by way of one of a plurality of manual selection modes, comprising the step of configuring the selection mode employed to be dependent upon the country within which the mobile radio communications device is identified as operating.

Advantageously, the method includes the step of storing a preferred manual selection mode within the mobile radio communications device.

In particular, the method can include the step of storing a preference list within the mobile radio communications device.

In particular, the method of configuring a mobile radio communications device includes the provision of a selection mode configured by the network operator.

Advantageously, such configuration can be supplied at customization and, can be provided by way of an over-the-air service.

As an alternative, the selection can be configured by the network operator and can be provided by initiating an update, or override, by way of a user interface.

Accordingly to still a further aspect of the present invention, there is provided a configuration device for configuring a mobile radio communications device for connection to one of a plurality of networks by way of one of a plurality of manual selection modes, the configuration device being arranged to identify selection modes for use with the mobile radio communications device and which are dependent upon the identification of the country in which the mobile radio communications device is located.

Advantageously, the configuration device is arranged to deliver the identified selection modes to a storage region within the mobile radio communications device.

In particular, the configuration device can be arranged to deliver a preference list to the mobile radio communications device.

Further, the configuration device can be arranged to provide the identification of the selection modes arranged to be used within the mobile radio communications device by way of a network operator.

In particular, the selection can be configured at customization and can be provided via an over-the-air service.

Alternatively, the configuration device can be arranged to override one or move previous selections by communication via a user interface of the mobile radio communications device.

Thus, it will be appreciated that the present invention can provide for a manual mode preference list that is stored in, for example, a non-volatile memory region of the mobile radio communications device and which can be sorted by country. In particular, the said sorting is achieved on the basis of the Mobile Country Code (MCC).

Then, when performing manual PLMN selection, the mobile radio communications device will behave according to the preferred selection mode of the country that the mobile radio communications device is identified as existing in, i.e. the preferred one of Modes I, II or III discussed above.

Advantageously, if, however, there is no entry for the country within which the mobile radio communications device finds itself, or the mobile radio communications device is not able to determine such country, then a default mode, such as Mode I, can take precedence.

Of course, it should be appreciated that the preference list is referred to and employed whenever the user attempts a manual PLMN selection.

### BRIEF DESCRIPTION OF DRAWINGS

FIG. 1 represents an example of embodiment of the invention.

### BEST MODE FOR CARRYING OUT THE INVENTION

The invention is described further hereinafter, by way of example only, with reference to the accompanying drawing which comprises a schematic diagram of a mobile radio communications device handset embodying an aspect of the present invention.

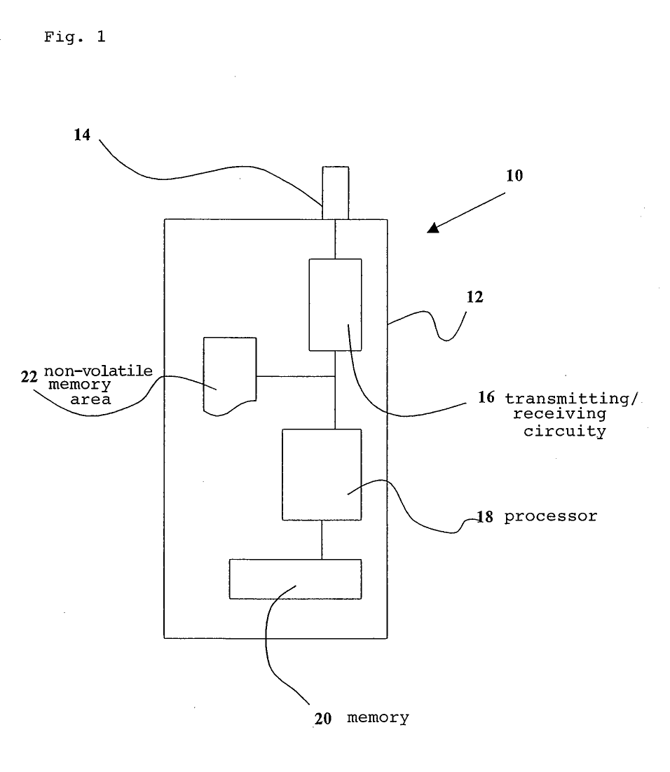

Turning now to the drawing FIG. 1, there is illustrated a mobile radio communications device 10 comprising a handset 12 having an antenna 14 which is connected to transmitting/receiving circuitry 16 operatively connected in a standard manner to a processor 18 and memory 20.

In addition, the handset 12 includes a non-volatile memory area 22 which is arranged to receive and store a preference list which indicates, on a country-by-country basis, the preferred manual PLMN selection mode to be adopted for each country.

Thus, when the handset 12 identifies itself as being in a particular country, reference is made to the contents of the non-volatile memory 22 to identify the preference list associated with that country and thereby seek selection of a PLMN by way of the most appropriate mode so as to, for example, retain home-operator revenues and also maintain quality of service for the user of the handset 12.

As mentioned in relation to this illustrated example, the preference list is stored within the non-volatile memory 22 although, as an alternative, it can be located within the USIM (not shown) of the handset 12. However, a particular feature of the preference list is that it is stored in a non-volatile manner so as to remain even when the handset 12 is powered-off.

According to a particularly advantageous aspect of the present invention, the preference list can be configured by the network operator during the customization phase and provide by way of an over-the-air service. Optionally, it can prove possible to initiate overriding or removal of existing entries by way of a user interface for the handset. This can also allow for the addition of entries or a change to the default manual selection mode.

In particular, the preference list stored in the non-volatile memory 22 generally consists of two parts.

First, there is provided a field that serves to indicate the preference of the country of the HPLMN of the handset 12. Since the MCC corresponding the country of the HPLMN is part of the International Mobile Subscriber Identity (IMSI) there is no need for the MCC to be repeated in that list. As above, if there is no entry found in this field Mode I can be assumed as the default mode.

The second part of the preference list comprises a second field where MCC/mode combinations are listed. Again, if there is no associated mode to a listed MCC, Mode I can be assumed as the default mode. As will be appreciated, for a situation in which the list is implemented solely within non-volatile memory, and when the USIM (not shown) for the handset 12 is changed, the list is then deleted and the default mode, for example, Mode I, is assumed for all manual PLMN selections.

As will be appreciated, the present invention is particularly advantageous in that, when the handset is nationally roaming, or pursuing friendly international roaming, it can be readily determined, via previous network-operator configuration, that, for example, manual selection is limited to Mode II selection such that some form of automated re-selection is always attempted.

As will be appreciated, the present invention can provide for a configuration tool for use by a network operator to indicate the preferences and to determine how the handset can manually select its PLMNs on a per country basis. For example, if one network is required to limit how the user may manually select the PLMN in its home country, but also in countries where that particular network is present, then that network operator will indicate Mode II selection at the top of its preference list for those countries. No restrictions however may be indicated for remaining countries such that if the default mode will be selected for any such further countries.

1. A mobile radio communications device arranged for connection to a plurality of networks and by way of a plurality of manual selection modes, and arranged such that the selection mode employed is dependent upon the country within which the mobile radio communications device operates.

2. A device as claimed in claim 1 and including storage means arranged for storing a preferred manual selection mode for each of the said plurality of countries.

3. A device as claimed in claim 2 and including a non-volatile memory area for storing the preferred manual selection mode.

4. A device as claimed in claim 2, and arranged such that the preferred manual selection mode is stored on a USIM of the device.

5. A device as claimed in claim 2, wherein the preferred manual selection mode forms part of a preference list stored on the mobile radio communications device.

6. A device as claimed in claim 2, and arranged to receive the preferred manual selection mode from the network operator.

7. A method of connecting a mobile radio communications device to one of a plurality of networks and by way of one of a plurality of manual connection modes, including the step of identifying the country within which the mobile radio communications device is operating and determining which of the plurality of manual connection modes is employed on the basis of the country identified.

8. A method as claimed in claim 7 and including the step of referring to a stored preferred manual selection mode forming part of a stored preference list.

9. A method as claimed in claim 8, wherein a separate list is provided for each of the said plurality of countries.

10. A method of configuring a mobile radio communications device for connection to one of a plurality of networks by way of one of a plurality of manual selection modes, —comprising the step of configuring the selection mode employed to be dependent upon the country within which the mobile radio communications device is identified as operating.

11. A method as claimed in claim 10 and including the step of storing a preferred manual selection mode within the mobile radio communications device.

12. A method as claimed in claim 11 and including the step of storing a preference list within the mobile radio communications device.

13. A method as claimed in claim 10, 11 or 12, and including the provision of a selection mode configured by the network operator.

14. A method as claimed in claim 13 wherein the configuration is supplied at customization.

15. A method as claimed in claim 13, wherein the selection mode is configured by a network operator through initiation of an update, or override, by way of a user interface.

16. A configuration device for configuring a mobile radio communications device for connection to one of a plurality of networks by way of one of a plurality of manual selection modes, the configuration device being arranged to identify selection modes for use with the mobile radio communications device and which are dependent upon the identification of the country in which the mobile radio communications device is located.

17. A device as claimed in claim 16 and arranged to deliver the identified selection modes to a storage region within the mobile radio communications device.

18. A device as claimed in claim 16 and arranged to deliver a preference list to the mobile radio communications device.

19. A device as claimed in claim 16, and arranged such that the configuration occurs at customization of the device and by way of an over-the-air service.

20. A device as claimed in claim 16, and arranged to override or move previous selections by communication via a user interface of the mobile radio communications device.

21. A mobile radio communication device substantially as hereinbefore described with reference to and as illustrated in the accompanying drawing.

22. A method of connecting a mobile radio communications device to one of a plurality of networks and substantially as hereinbefore described with reference to the accompanying drawing.

23. A method of configuring a mobile radio communications device substantially as hereinbefore described with reference to the accompanying drawing.

24. A configuration device for configuring a mobile radio communications device and substantially as hereinbefore described with reference to the accompanying drawing.
